(19) United States
(12) Patent Application Publication
(10) Pub. No.: US 2010/0330374 A1
(43) Pub. Date: Dec. 30, 2010

(54) PRESSURE MEMBER, FIXING DEVICE, AND IMAGE FORMING APPARATUS

(75) Inventors: Jun KIMURA, Kanagawa (JP); Yasuyuki KOBAYASHI, Kanagawa (JP); Yasushi NAGATA, Kanagawa (JP); Takanori SASAKI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/635,336

(22) Filed: Dec. 10, 2009

(30) Foreign Application Priority Data
Jun. 26, 2009 (JP) 2009-152522

(51) Int. Cl. B32B 27/00; G03G 15/20

(52) U.S. Cl. 428/421; 399/333

(57) ABSTRACT

A pressure member is used for fixing in electrophotography and includes at least a substrate, an elastic layer provided on the substrate, and a surface layer includes carbon and a fluororesin having a structure represented by Formula (1):

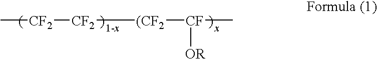

wherein R represents CF₃, C₂F₅, or C₃F₇, and x represents a numeral from 0.045 to 0.12.

### CROSS-REFERENCE TO RELATED APPLICATION

This application is based on and claims priority under 35 USC 119 from Japanese Patent Application No. 2009-152522 filed on Jun. 26, 2009.

### BACKGROUND

1. Technical Field

The present invention relates to a pressure member, a fixing device, and an image forming apparatus.

2. Related Art

In electrographic image forming apparatuses such as copiers, laser printers, and facsimiles, a toner image is fixed by applying heat and pressure to an unfixed toner image formed on a recording material, using a fixing device.

### SUMMARY

According to an aspect of the invention, there is provided a pressure member used for electrophotography, the pressure member including at least a substrate, an elastic layer provided on the substrate, and a surface layer that is provided on the substrate and includes carbon and a fluororesin having a structure represented by the following Formula (1):

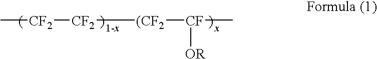

wherein, in Formula (1), R represents CF₃, C₂F₅, or C₃F₇, and x represents a numeral from 0.045 to 0.12.

### BRIEF DESCRIPTION OF THE DRAWINGS

Exemplary embodiments of the present invention will be described in detail based on the following figures, wherein:

FIG. 1 is a schematic view showing a cross section of a pressure roller as an example of the pressure member according to an exemplary embodiment;

FIG. 2 is a schematic view showing a cross section of an example of the fixing device according to the present exemplary embodiment; and

FIG. 3 is a schematic structure diagram showing an example of the image forming apparatus according to the present exemplary embodiment.

### DETAILED DESCRIPTION

Exemplary embodiments of the present invention are described below.

The pressure member according to an exemplary embodiment of the invention is used for fixing performed in electrophotography, and includes at least a substrate, an elastic layer provided on the substrate, and a surface layer that is provided on the elastic layer and that includes carbon and a fluororesin having the structure represented by Formula (1) (hereinafter referred to as “specific fluororesin” in some cases):

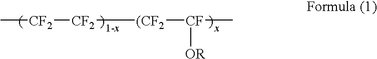

In Formula (1), R represents CF₃, C₂F₅, or C₃F₇, and x represents a numeral from 0.045 to 0.12 (or approximately from 0.045 to approximately 0.12).

When a pressure member having a surface layer that includes, for obtaining intended resistivity, carbon and a fluororesin and that is placed on an elastic layer is repeatedly used in a roller nip or belt nip system, the pressure member tends to have a short life due to its inferior resistance to bending and cracking, for example cracking in the surface layer.

In particular, in recent high-speed electrophotographic apparatuses, the temperature difference between a paper feeding portion and a non-paper-feeding portion of members is often large. When a carbon-added fluororesin is used under such a condition, the outer diameter difference between the fixing member and the pressure member due to the temperature difference results in a peripheral speed difference during rotation. As a result, the fluororesin layer at the nip portion, particularly at an paper end portion, is repeatedly subject to torsional stress. The repeated torsional stress results in cracks in the fluororesin layer, thereby shortening the life of the pressure member.

In contrast, the inventors have found that the pressure member according to the present exemplary embodiment of the invention may have high durability, as described below. The pressure member according to the present exemplary embodiment includes the substrate, the elastic layer provided on the substrate, and the specific surface layer provided on the elastic layer. When a recording medium is pressure-contacted with the pressure member and conveyed, the elastic layer and the surface layer is deformed. However, when the specific fluororesin in which the x value in Formula (1) is from 0.045 to 0.12 is used as the fluororesin included in the surface layer, the durability of the pressure member may be improved, and deterioration of the image may be prevented. Regarding the reason therefor, the inventors have found that when the resin in which the x value is from 0.045 to 0.12 is used in the pressure member, the surface layer may sufficiently deform to follow the compression of the elastic layer when pressed, release property may be excellent, and effective release of paper may be achieved.

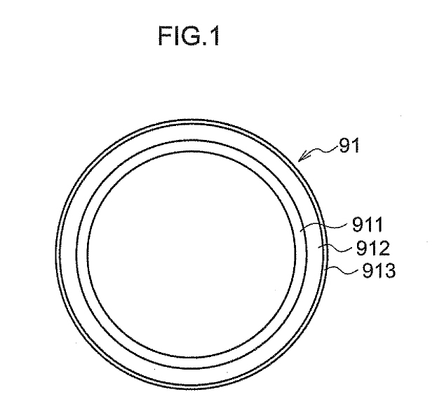

The pressure roller as an example of the pressure member according to the present exemplary embodiment of the invention is described with reference to FIG. 1. FIG. 1 is a schematic view showing a cross section of an example of the pressure member according to the present exemplary embodiment of the invention. The pressure member according to the present exemplary embodiment of the invention may be in the fowl of a roller or an endless belt.

Pressure member (pressure roller) 91 includes, for example, substrate 911, elastic layer 912 provided on substrate 911 and surface layer 913.

Substrate 911 includes, for example, a common metal such as aluminum, iron, or SUS, or a heat-resistant resin such as PPS (polyphenylene sulfide), polyimide, polyester, polyamide, or LCP (liquid crystal polymer), or a material obtained by reinforcing the heat resistant resin by addition of glass fiber or the like.

In order to achieve a high image quality, the material of elastic layer 912 may be a material (such as silicone rubber or fluorocarbon rubber) that has a durometer hardness of from A10 to A40 (or from approximately A10 to approximately A40), the compression set (defined in JIS K6262) of the elastic layer material may be small, and the modulus of repulsion elasticity (defined in JIS K6255) may be large. The material may be a silicone rubber.

Surface layer 913 is disposed on the surface of elastic layer 912, and includes the fluororesin represented by Formula (1) and carbon dispersed in the fluororesin.

In Formula (1), R represents CF₃, C₂F₅, or C₃F₇, and preferably represents CF₃ or C₂F₅. In Formula (1), x represents a numeral from 0.045 to 0.12 (or from approximately 0.045 to approximately 0.12), preferably from 0.045 to 0.10 (or from approximately 0.045 to approximately 0.10), more preferably from 0.045 to 0.08 (or approximately from 0.045 to approximately 0.08), and even more preferably from 0.048 to 0.065 (or from approximately 0.048 to 0.065). When the value of x is within the range, the pressure member may have favorable release property, and may exhibit high durability.

The carbon included in the surface layer may be a carbon black such as ketjen black or acetylene black.

The surface layer may contain two or more carbon blacks. In this case, the respective carbon blacks may differ in electrical properties. The respective carbon blacks may differ in at least one physical property such as specific surface area determined by BET method based on nitrogen adsorption, degree of oxidation treatment, or DBP oil absorption amount.

Specific examples of carbon blacks include KETJENBLACK EC, KETJENBLACK EC300J, and KETJENBLACK EC600JD manufactured by Lion Corporation, TOKA BLACK 45500 and TOKA BLACK #4500 manufactured by Tokai Carbon Co., Ltd., carbon blacks #3030B, 43050B, and #3230B manufactured by Mitsubishi Chemical Corporation.

The surface layer may further include another (electrically) conductive agent. Examples of another conductive agent include metals such as aluminum and nickel, metal oxide compounds such as tin oxide, and potassium titanate. The conductive agent may be used singly or in combination of two or more thereof.

The carbon content of the surface layer is preferably from 1% to 7% (or from approximately 1% to approximately 7%) by weight, and more preferably from 1.5% to 5% (or from approximately 1.5% to approximately 5%) by weight. When the carbon content is within the range, electrical conductivity of the surface layer may be ensured, and thus a problem associated with electrification may be prevented. Therefore, the surface layer may be excellent in recording material release property, and the pressure member may have excellent durability.

Examples of a method of dispersing carbon in the fluororesin represented by the formula (1) include a method of kneading carbon and the fluororesin using a kneading machine such as a kneader or biaxial roll while heating, and a method using a biaxial extrusion kneader. The method using a biaxial extrusion kneader is preferred.

In order to improve durability, the surface layer may further include an additive such as a fluororesin (such as PTFE) or a silicone resin, to such an extent that the image quality is not impaired. The content of the additive may be as low as possible with a view to achieving high release property.

The volume resistivity of the surface layer is preferably from 10⁴ Ωcm to 10¹⁰ Ωcm (or from approximately 10⁴ Ωcm to approximately 10¹⁰ Ωcm), and more preferably from 10⁴ Ωcm to 10⁷ Ωcm (or from approximately 10⁴ Ωcm to approximately 10⁷ Ωcm). When the volume resistivity is within the range, electrical conductivity of the surface layer may be ensured and problems associated with electrification may be avoided, while the pressure member may have excellent durability.

The volume resistivity is measured using double ring electrode method,

In the pressure member according to the present exemplary embodiment, the substrate may have a certain thickness with which strength sufficient to prevent permanent deformation under loads may be prevented, which may depend on the kind of the material of the substrate. The thickness of the elastic layer may be from 1 mm to 12 mm (or from approximately 1 mm to approximately 12 mm), and the thickness of the surface layer may be from 50 μm to 150 μm (or from approximately 50 μm to approximately 150 μm). When the thickness of the elastic layer is 1 mm or more, sufficient elasticity may be transmitted to the surface of the pressure member, and when the thickness of the elastic layer is 12 mm or less, a wrinkle of the recording medium may be prevented. When the thickness of the surface layer is 50 μm or more, wrinkle of the surface layer may be prevented even when repeatedly subjected to mechanical stress in the fixing device, and when the thickness of the surface layer is 150 μm or less, the surface hardness of the pressure member may be moderate so that a desired nip width necessary for fixing may be obtained.

The thickness of the surface layer is measured using a double scanning high precision laser measuring instrument (manufactured by Keyence Corp.).

The thickness of the elastic layer is measured as follows: elastic layer 912 and surface layer 913 are separated from pressure member 91 by cutting, the total thickness of elastic layer 912 and surface layer 913 is measured using a constant-pressure thickness gauge (trade name: PG-02, manufactured by Teclock Corporation), from which the thickness of surface layer 913 is subtracted to determine the thickness of elastic layer 912.

Each thickness measurement is performed by measuring the thickness at twelve points; one measurement point located at a distance of 20 mm from one end of a roller or endless belt in the axial direction, another measurement point located at a distance of 20 mm from the other end of the roller or endless belt in the axial direction, and still another measurement point located at the center region in the axial direction constitute a set of measurement points, and four sets of the measurement points are provided at intervals of 90° in the circumferential direction, and the average of measurement values at the twelve measurement points is used as the thickness. The thickness of elastic layer 912 and surface layer 913 of each pressure member are determined as described above.

In the production of the pressure member according to the present exemplary embodiment of the invention, the elastic layer may be formed by extruding silicone rubber or the like onto the substrate, which may be in the form of a roll or endless belt, so as to cover the substrate, or by coating silicone rubber or the like on the substrate and heat-molding the resultant so as to cover the substrate.

When the pressure member is in a roll form, the pressure member may be formed by molding, by melt extrusion, the specific fluororesin into a tube shape having a smaller diameter than that of the desired pressure member roll, and adhering, by vulcanization, the tube-shaped specific fluororesin at an expansion ratio of from 1 to 10% to rubber that has been poured into a metallic die so as to form an integral covering. The inner surface of the tube may be previously subjected to a surface treatment, for example, excimer treatment.

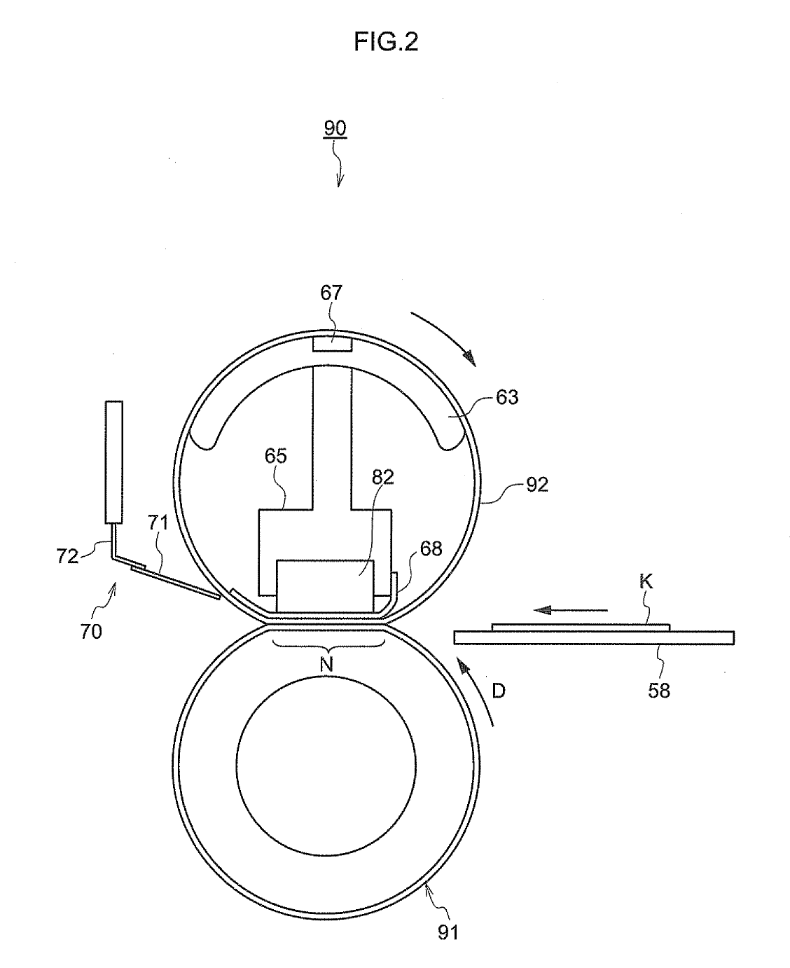

Fixing device 90 is described below. FIG. 2 is a schematic view showing the structure of fixing device 90 according to the present exemplary embodiment.

As shown in FIG. 2, fixing device 90 includes of fixing belt 92, which is an endless belt, and pressure roll 91 as an example of a rotatably-driven rotator. Fixing belt 92 is configured by plural layers—a base material layer and another layer (release layer) that is provided on the base material layer. Pressure roll 91 is the above-described pressure member according to the present exemplary embodiment. Arrow D in FIG. 2 indicates the rotation direction of the pressure roll.

Fixing device 90 is not limited to the above-described structure, and may adopt another known system such as a system in which the fixing member (heating member) is a roll and the pressure member is also a roll, or a system in which the fixing member is a roll and the pressure member is a belt. In the present exemplary embodiment, the above-described pressure member according to the present exemplary embodiment is applied as the pressure member in each system.

Fixing belt 92 is disposed at the toner-image-bearing side of paper (recording medium) K, and ceramic heater 82, which is a heating resistor as an example of a heating unit, is disposed at the inner side of fixing belt 92. Ceramic heater 82 supplies heat to a nip region N.

The surface of ceramic heater 82 at the pressure roll 91 side is a flat. Ceramic heater 82 is disposed to be pressed towards pressure roll 91 with fixing belt 92 therebetween so that nip region N is formed. Accordingly, ceramic heater 82 also serves as a pressure member. After passing through nip region N, paper K is released from fixing belt 92 at the exit of nip region N (release-nip portion) due to a change in the curvature of fixing belt 92.

Low friction sheet 68 is arranged between the inner circumferential surface of fixing belt 92 and ceramic heater 82 thereby decreasing the sliding resistance between the inner circumferential surface of fixing belt 92 and ceramic heater 82. Low friction sheet 68 may a separate member from ceramic heater 82 or may be integrated with ceramic heater 82.

In fixing device 90, fixing belt 92 is an endless belt, original shape of which is cylindrical. Fixing belt 92 is configured by a base layer and (i) a release layer covering the pressure roll 91 side of the base layer or (ii) release layers respectively provided on the opposite sides of the base layer.

Fixing belt 92 is rotatably supported by pressure pad 65, belt travel guide 63, and edge guides (not shown) arranged at the inner side of fixing belt 92. Fixing belt 92 is disposed to contact pressure roll 91 at nip region N in a state in which fixing belt 92 is pressed against pressure roll 91.

Lubricant applying member 67 is provided on pressure pad 65 in a longitudinal direction of fixing device 90. Lubricant applying member 67 is in contact with the inner circumferential surface of fixing belt 92, and applies a lubricant in an adequate amount.

Release member 70 as a release aid unit is disposed at the downstream of nip region N of fixing belt 92. Release baffle 71 extends towards fixing belt 92 in the orientation (counter direction) that is opposite to the rotation direction of fixing belt 92. Release member 70 is supported by holder 72 and is located in proximity to fixing belt 92.

Edge guides (not shown) are arranged at both ends of fixing belt 92 in the width direction thereof. The distance between the inner surfaces of the edge guides that oppose each other is equal to the width of fixing belt 92. During the rotation of fixing belt 92, the ends of fixing belt 92 are respectively in contact with the inner sides of the edge guides so that a movement of fixing belt 92 in the width direction (belt walking) is regulated. In this manner, the edge guides prevent the deviation of fixing belt 92.

Paper K having an unfixed toner image thereon is guided by entrance guide 58 to nip region N of fixing device 90. When paper K passes through nip region N, the toner image on paper K is fixed by the pressure applied to nip region N and the heat supplied from the ceramic heater positioned at the fixing belt 92 side.

In fixing device 90, pressure roll 91 has a reverse crown shape (flared shape) having larger outside diameters at both ends than at the center. The inner surface of fixing belt 92 also has a curved shape such that the curved shape conforms to the surface shape of pressure roll 91 at the nip region. In this structure, when the paper passes through the nip region, paper is stretched by tensile force applied by pressure roll 91 in width direction from the center of the paper towards the ends of the paper, and fixing belt 92 is also stretched in the surface width direction.

Therefore, in fixing device 90, slipping between fixing belt 92 and paper K is prevented in the whole region from the center to the both ends of fixing belt 92.

The heating source may be ceramic heater 82, a halogen lamp, or any device using electromagnetic induction heating by an electromagnetic induction coil.

The image forming apparatus according to the present exemplary embodiment of the invention includes an image holder, an electrostatic latent image forming unit that forms an electrostatic latent image on the image holder, a developing unit that develops the electrostatic latent image into a toner image using a toner, a transfer unit that transfers the toner image onto a recording medium, and a fixing unit that fixes the transferred toner image onto the recording medium, wherein the fixing unit is the above-described fixing device according to the present exemplary embodiment.

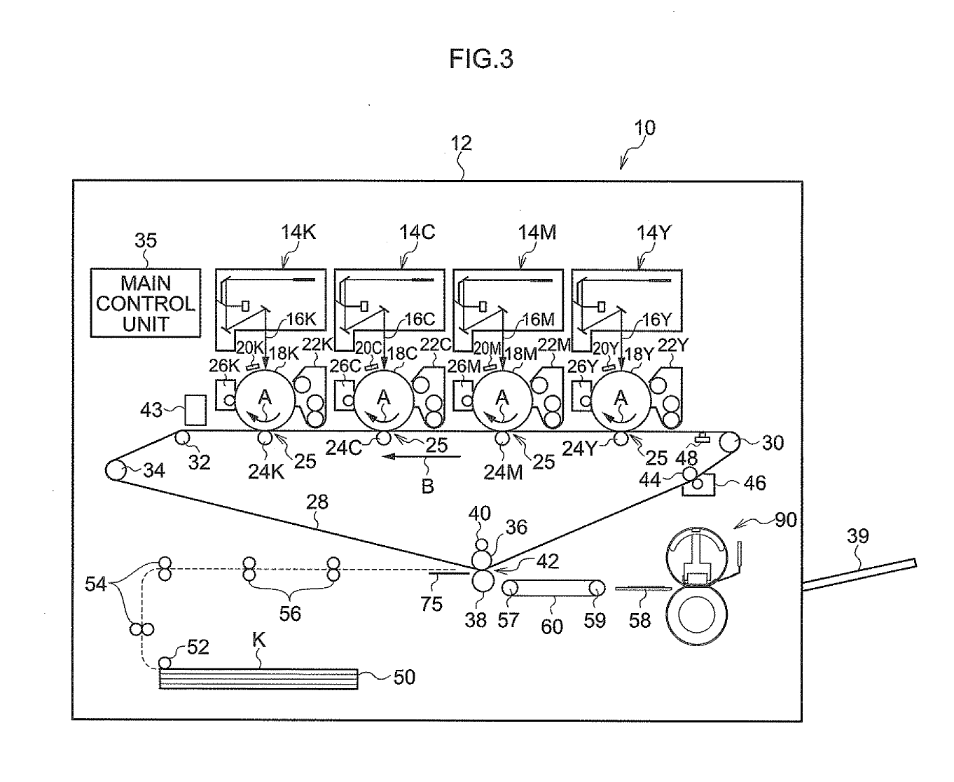

An example of the image forming apparatus according to the present exemplary embodiment is described below with reference to FIG. 3. FIG. 3 is a schematic structure diagram showing an example of the image forming apparatus according to the present exemplary embodiment.

In image forming apparatus 10, scanning-beam emitting devices 14Y, 14M, 14C, and 14K that emits light beams corresponding to yellow (Y), magenta (M), cyan (C), and black (K) toners, respectively, are fixed in housing 12 that encloses the main body of image forming apparatus 10. In addition, main control unit 35 that regulates the action of each part of image forming apparatus 10 is disposed adjacent to scanning-beam emitting device 14K.

Scanning-beam emitting devices 14Y, 14M, 14C, and 14K emit light beams 16Y, 16M, 16C, and 16K corresponding to respective color toners in a scanning manner by changing the directions of the light beams emitted from the respective light sources by using rotatable multi-faceted mirrors (polygon mirrors) (not shown) and plural optical components that reflect the light beams such as reflection mirrors.

Light beams 16Y, 16M, 16C, and 16K are guided to corresponding photoreceptors (image holders) 18Y, 18M, 18C, and 18K, respectively. Each of photoreceptors 18Y, 18M, 18C, and 18K can be rotated in the direction of arrow A by a driving unit (not shown) that has a motor and a gear.

Chargers 20Y, 20M, 20C, and 20K that charge surfaces of photoreceptors 18Y, 18M, 18C, and 18K, respectively, are respectively provided at the upstream of irradiation positions of light beams 16Y, 16M, 16C, and 16K in the rotation direction of photoreceptors 18Y, 18M, 18C, and 18K.

In addition, developing devices (developing units) 22Y, 22M, 22C, and 22K that perform development by providing Y, M, C, and K toners onto photoreceptors 18Y, 18M, 18C, and 18K are provided at the downstream of irradiation positions of light beams 16Y, 16M, 16C, and 16K in the rotation direction of photoreceptors 18Y, 18M, 18C, and 18K.

Intermediate transfer belt 28, onto which the developed toner images are primary-transferred, is arranged at the downstream of developing devices 22Y, 22M, 22C, and 22K in the rotation direction of photoreceptors 18Y, 18M, 18C, and 18K.

Intermediate transfer belt 28 may be, for example, an endless film belt including a resin, such as polyimide or polyimide, that contains an appropriate amount of an antistatic agent such as carbon black. The belt has a volume resistivity of, for example, from 10⁶ to 10¹⁴ Ωcm, and a thickness of, for example, about 0.1 mm.

Primary transfer rolls 24Y, 24M, 24C, and 24K that transfers the toner images of respective colors formed on photoreceptors 18Y, 18M, 18C, and 18K to intermediate transfer belt 28 are arranged on the inner side of intermediate transfer belt 28 at positions at which intermediate transfer belt 28 contacts photoreceptors 18Y, 18M, 18C, and 18K, respectively. Primary transfer rolls 24Y, 24M, 24C, and 24K respectively form primary transfer sections 25 that primary-transfer the toner images from photoreceptor 18Y, 18M, 18C, and 18K to intermediate transfer belt 28.

Each of primary transfer rolls 24Y, 24M, 24C, and 24K has a shaft (not shown) and a sponge layer (not shown) as an elastic layer that is bonded to the circumferential surface of the shaft. The shaft is, for example, a cylindrical column made of a metal such as iron or SUS. The sponge layer is made of, for example, a blend rubber including NBR, SBR, and EPDM mixed with a conductive agent such as carbon black, and is in the form of a spongy cylinder roll having a volume resistivity of from 10^{7.5} Ωcm to 10^{8.5} Ωcm.

Primary transfer rolls 24Y, 24M, 24C, and 24K are pressed against photoreceptors 18Y, 18M, 18C, and 18K, respectively, with intermediate transfer belt 28 sandwiched therebetween. Voltages (primary transfer biases) having a polarity opposite to the charging polarity of the respective toners (the charging polarity of the toners is assumed to be negative polarity for the purpose of explanation; the same applies hereinafter) are respectively applied to primary transfer rolls 24Y, 24M, 24C, and 24K by a voltage application unit (not shown). As a result, toner images on respective photoreceptors 18Y, 18M, 18C, and 18K are sequentially and electrostatically attracted onto intermediate transfer belt 28, whereby a superposed toner image is formed on intermediate transfer belt 28.

Cleaners 26Y, 26M, 26C, and 26K that remove the residual toners from photoreceptors 18Y, 18M, 18C, and 18K are provided at the downstream of primary transfer rolls 24Y, 24M, 24C, and 24K, respectively, in the rotation direction of photoreceptors 18Y, 18M, 18C, and 18K.

Driving roll 30 and supporting roll 32 are provided at the inner side of intermediate transfer belt 28. Driving roll 30 is driven by a motor (not shown) having excellent constant-speed driving property and rotates intermediate transfer belt 28. Supporting roll 32 supports intermediate transfer belt 28 which linearly extends along the arrangement direction of photoreceptors 18Y, 18M, 18C, and 18K. Intermediate transfer belt 28 is driven to circulate in the direction of arrow B thereby.

In addition, tension application roll 34 that applies tension to intermediate transfer belt 28 is provided at the inner side of intermediate transfer belt 28.

Secondary transfer section 42 that transfers the toner image from intermediate transfer belt 28 onto recording medium K is provided at the downstream of tension application roll 34 in the rotation direction of intermediate transfer belt 28.

Secondary transfer section 42 is configured by secondary transfer roll (transfer unit) 38 disposed at a side of intermediate transfer belt 28 that retains the toner image, and supporting roll 36 that supports intermediate transfer belt 28 at the secondary transfer position.

Secondary transfer roll 38 is configured by a shaft (not shown) and a sponge layer as an elastic layer that is bonded to the circumferential surface of the shaft. The shaft is, for example, a cylindrical column made of a metal such as iron or SUS. The sponge layer is made of, for example, a blend rubber including NBR, SBR, and EPDM mixed with a conductive agent such as carbon black, and is in the form of a spongy cylinder roll having a volume resistivity of from 1×10^{7.5} Ωcm to 1×10^{8.5} Ωcm.

Secondary transfer roll 38 is pressed against supporting roll 36, which supports intermediate transfer belt 28 at the secondary transfer position, with intermediate transfer belt 28 sandwiched therebetween. Secondary transfer roll 38 is grounded, and a secondary transfer bias is applied between supporting roll 36 and secondary transfer roll 38, whereby the toner image is secondary-transferred onto recording medium K which has been conveyed to secondary transfer section 42.

Supporting roll 36 is configured by, for example, a surface portion that is a tube made of a blend rubber of an EPDM and NBR in which carbon is dispersed and an inside portion made of an EPDM rubber. Supporting roll 36 has a surface resistivity of from 1×10⁷ Ω/sq to 10¹⁰ Ω/sq and a durometer hardness of, for example, C70. The durometer hardness is a value measured in accordance with HS K 6253 using a durometer type C (for example, trade name: ASKER C, manufactured by Koubunshi Keiki Co., Ltd.).

Supporting roll 36 that supports intermediate transfer roll 28 at the secondary transfer position is disposed at the backside of intermediate transfer belt 28 and serves as a counter electrode of secondary transfer roll 38. A secondary transfer bias is stably applied to supporting roll 36 through a power feeding metal roll 40 which is made of metal and which is disposed in contact with supporting roll 36.

Intermediate transfer belt cleaner 46 that removes residual toner and paper powder from intermediate transfer belt 28 after the secondary transfer is placed at the downstream of secondary transfer section 42 in the rotation direction of intermediate transfer belt 28, and intermediate transfer belt cleaner can be contacted with and separated from intermediate transfer belt 28. Cleaning roll 44 is provided at the inner side of intermediate transfer belt 28 at intermediate transfer belt cleaner 46.

Home position sensor 48 that generates a reference signal for synchronizing the image formation processes using respective toners is provided at the upstream of primary transfer roll 24Y for yellow toner.

Home position sensor 48 generates a reference signal upon detection of a mark provided on the back side of intermediate transfer belt 28. Based on the reference signal, main control unit 35 activates each component of the image forming apparatus 10 to initiate image formation.

Image density sensor 43 that controls image quality is provided at the downstream of primary transfer roll 24K for black toner.

Paper feeding unit 50 that accommodates recording medium K is provided at a lower position of image forming apparatus 10. Pickup roll 52 that feeds and conveys recording medium K at specified time points is provided at one end of paper feeding unit 50.

Plural pairs of conveyor rolls 54 and plural pairs of conveyor rolls 56, both of which convey recording medium K fed by pickup roll 52 to secondary transfer section 42, are provided at the upper side of pickup roll 52. Conveyor rolls 54 and 56 are driven and rotated by a driving unit (not shown) having a motor and a gear.

Entrance guide 75 for sending recording medium K to secondary transfer section 42 is provided at the downstream of conveyor rolls 56 in the conveyance direction of recording medium K.

Conveyor belt 60 that conveys recording medium K after the completion of the secondary transfer of the toner image to fixing device 90 is provided in the direction of discharge of recording medium K from secondary transfer section 42. Conveyor belt 60 is stretched by supporting rolls 57 and 59, and is moved by a driving unit (not shown) having a motor and a gear.

Entrance guide 58 that introduces recording medium K into fixing device 90 is provided at the entrance side of fixing device 90. Paper accumulation unit 39 anchored to housing 12 of image forming apparatus 10 is provided at the exit side of fixing device 90.

An example of the procedure of image formation in image forming apparatus 10 is described below.

First, image data outputted from an image capturing device or a personal computer (not shown) are subjected to image processing by an image processing apparatus (not shown). In the image processing apparatus, image processing is performed on the inputted reflectance data, such as various kinds of image editing processes including shading correction, correction of positional displacement, conversion of brightness/color space, gamma correction, elimination of frames, color editing, and editing by movement. The processed image data are converted into tone date for four colors of Y, M, C, and K, and then outputted to scanning-beam emitting devices 14Y, 14M, 14C, and 14K.

Scanning-beam emitting devices 14Y, 14M, 14C, and 14K emit light beams 16Y, 16M, 16C, and 16K to the photoreceptors 18Y, 18M, 18C, and 18K, respectively, according to the inputted tone data for the four colors.

The surfaces of photoreceptors 18Y, 18M, 18C, and 18K have been electrified by chargers 20Y, 20M, 20C, and 20K, and the surfaces are exposed to light beams 16Y, 16M, 16C, and 16K, respectively, whereby electrostatic latent images are formed. The electrostatic latent images thus formed are developed by developing devices 22Y, 22M, 22C, and 22K, respectively, into toner images of respective colors (Y, M, C, and K).

Subsequently, the toner images formed on photoreceptors 18′Y, 18M, 18C, and 18K are transferred onto intermediate transfer belt 28 in primary transfer sections 25. The transferring is performed by primary transfer rolls 24Y, 24M, 24C, and 24K applying voltages (primary transfer biases) having a polarity opposite to the charging polarity (negative polarity) of the toners to intermediate transfer belt 28, thereby sequentially transferring the toner images one on another, onto a surface of intermediate transfer belt 28.

Subsequently, intermediate transfer belt 28 to which the toner image has been transferred is conveyed to secondary transfer section 42.

Pickup roll 52 rotates and sends out recording medium K from paper feeding unit 50 in synchronization with the conveyance of toner image to secondary transfer section 42.

Recording medium K sent out by pickup roll 52 is conveyed by conveyor rolls 54 and 56, and arrives at secondary transfer section 42 via entrance guide 75. Before arriving at secondary transfer section 42, recording medium K is temporarily stopped, and an alignment roll (not shown) is rotated in synchronization with the rotation timing of intermediate transfer belt 28 having the toner image thereon, thereby adjusting the positional relationship between recording medium K and the toner image.

In secondary transfer section 42, secondary transfer roll 38 is pressed against supporting roll 36 with intermediate transfer belt 28 sandwiched between secondary transfer roll 38 and supporting roll 36. Recording medium K, which has been conveyed at right timing, is nipped between intermediate transfer belt 28 and secondary transfer roll 38.

At this time, power feeding roll 40 applies a voltage (secondary transfer bias) having the same polarity as the charging polarity (negative polarity) of the toner, whereby a transfer electric field is formed between secondary transfer roll 38 and supporting roll 36 which supports intermediate transfer belt 28 at the secondary transfer position. The unfixed toner image held on intermediate transfer belt 28 is pressed by secondary transfer roll 38 and supporting roll 36, and the entire unfixed toner image is electrostatically transferred all at once onto recording medium K.

Subsequently, recording medium K, onto which the toner image has been electrostatically transferred, is conveyed to conveyor belt 60 by secondary transfer roll 38 in the state in which recording medium K is released from intermediate transfer belt 28.

Recording medium K is conveyed on conveyor belt 60 to fixing device 90 at a conveyance speed most suitable for fixing device 90. The unfixed toner image on recording medium K conveyed to fixing device 90 is fixed onto recording medium K by fixing device 90.

Recording medium K having the fixed image thereon is discharged to, and accumulated in, paper accumulation unit 39.

After the transfer of the image onto recording medium K is completed, the residual toner on intermediate transfer belt 28 is conveyed to intermediate transfer belt cleaner 46 as intermediate transfer belt 28 rotates, and the residual toner is removed from intermediate transfer belt 28.

In this manner, image formation by image forming apparatus 10 is performed.

### EXAMPLES

Exemplary embodiments of the present invention are described below in more detail with reference to examples, but the invention is not limited to these examples. Hereinafter “parts” means parts by weight.

### Example 1

An aluminum core bar (trade name: A-5052, a cylindrical body having an outside diameter of 33.8 mm and a wall thickness of 3 mm) is used as a substrate of a pressure member.

A liquid silicone rubber (trade name: DY35-4039A/B, manufactured by Dow Corning Toray Co., Ltd.) is used for an elastic layer.

2.5 parts of carbon (trade name: ketjen black EC, manufactured by Lion Corp.) are added to 97.5 parts of a tetrafluoroethylene-perfluoroethyl vinyl ether copolymer (trade name: PF-059, copolymerization molar ratio is 95.1:4.9, manufactured by Du Pont-Mitsui Fluorochemicals Company, Ltd.) as the specific fluororesin. The mixture is extruded and kneaded using a biaxial kneader.

The kneaded product is formed into a tube (surface layer, tube diameter: 62.5 mm, tube thickness: 100 μm) at 370° C. using an extruder. Subsequently, the inner surface of the tube is subjected to chemical etching treatment using TETRA-ETCH manufactured by Junkosha Inc. The tube is placed between the substrate made of the aluminum core bar and an outer die having a diameter of 65 mm, and a primer (trade name: DY39-125A/B, manufactured by Dow Corning Toray Co., Ltd.) is applied to the treated surface of the tube. Thereafter, the core bar, the surface of which has been treated with a primer (trade name: DY39-051A/B manufactured by Dow Corning Toray Co., Ltd.), is fixed concentrically with the outer die, and the liquid silicone rubber is injected into the space between the tube and core bar. The whole die is heated at 100° C. for 30 minutes, thereby vulcanizing the liquid silicone rubber (durometer hardness: 30/A) and vulcanization-bonding the core bar to the fluororesin tube. The liquid silicone rubber serves as the elastic layer. The vulcanized product is cooled, removed from the die, and subjected to secondary vulcanization at 200° C. for 4 hours, thus providing a pressure roll.

### Examples 2 to 6 and Comparative Examples 1 to 4

Pressure rolls of Examples 2 to 6 and Comparative Examples 1 to 4 are prepared in the same manner as in Example 1, except that the specific fluororesin used in Example 1 is replaced by the specific fluororesins listed in Table 1.

Each fluororesin is prepared by polymerization using an ordinary method at the molar ratio of tetrafluoroethylene to perfluoroalkyl vinyl ether shown in Table 1. Table 1 also shows the actual content of perfluoroalkyl vinyl ether in each material as measured by solid ¹⁹F-NMR and solid ¹³C-NMR under the following conditions.

Solid ¹⁹F-NMR Measurement

Measuring equipment: CMX300 manufactured by Chemagnetic, 5 mm probe

Measurement method: depth 2 method (resonance frequency 282.67 MHz)

Measurement conditions: 90° Pulse 3.0 μs, band width: 100 kHz, repeating time: 5 seconds

Rotation speed: 8 kHz, number of transients: 32

Measurement temperature: 240° C.

Solid ¹³C-NMR Measurement

Measuring equipment: CMX300, manufactured by Chemagnetic, 5 min probe

Measurement method: single pulse method (resonance frequency 75.5563 MHz)

Rotation speed: 8 kHz, number of transients: 800

Measurement temperature: 240° C.

TABLE 1

| | | Proportion of |
|---|---|---|
| | | perfluoroalkyl |
| | | vinyl ether |
| | Composition of fluororesin | (mol %) |
| Example 1 | tetrafluoroethylene/perfluoroethyl | 4.9 |
| | vinyl ether copolymer | |
| Example 2 | tetrafluoroethylene/perfluoroethyl | 6.4 |
| | vinyl ether copolymer | |
| Example 3 | tetrafluoroethylene/perfluoroethyl | 4.5 |
| | vinyl ether copolymer | |
| Example 4 | tetrafluoroethylene/perfluoroethyl | 9.9 |
| | vinyl ether copolymer | |
| Example 5 | tetrafluoroethylene/perfluoropropyl | 4.6 |
| | vinyl ether copolymer | |
| Example 6 | tetrafluoroethylene/perfluoroethyl | 10.2 |
| | vinyl ether copolymer | |
| Comparative | tetrafluoroethylene/perfluoropropyl | 1.6 |
| Example 1 | vinyl ether copolymer | |
| Comparative | tetrafluoroethylene/perfluoroethyl | 3.0 |
| Example 2 | vinyl ether copolymer | |
| Comparative | tetrafluoroethylene/perfluoropropyl | 3.5 |
| Example 3 | vinyl ether copolymer | |
| Comparative | tetrafluoroethylene/perfluoropropyl | 4.3 |
| Example 4 | vinyl ether copolymer | |

<Evaluation>

Each of the prepared pressure rolls is used as the pressure roll in an image forming apparatus (black-and-white copier, trade name: 4112, manufactured by Fuji Xerox Co., Ltd.), and is subjected to cracking evaluation test and roll surface wrinkle test under the following conditions. The results are listed in Table 2.

(Cracking Evaluation Test)

A continuous running test is performed in which A4-sized copy paper sheets P (basis weight: 64 gsm, manufactured by Fuji Xerox Co., Ltd.) are continuously fed in the transverse direction of the sheets, and a ladder chart having an image density of 5% is formed thereon. The surface of the pressure roll is visually observed every time 50,000 sheets are discharged. The number of sheets discharged before a crack occurs in the surface is counted. The evaluation is terminated when 1,200,000 sheets are discharged.

(Roll Surface Wrinkle Test)

A continuous running test is conducted in the same manner as in the cracking evaluation test. The surface of the pressure roll is visually observed every time 50,000 sheets are discharged, and the number of sheets discharged before wrinkle appears in the surface is counted. The evaluation is terminated when 1,200,000 sheets are discharged.

TABLE 2

| | Volume | Occurrence of crack | | |
|---|---|---|---|---|
| | resistivity | Number of | | Wrinkle on |
| | (logΩcm) | sheet | Judgment | roll surface |
| Example 1 | 5.3 | 1,200,000 | Satisfactory | None |
| Example 2 | 5.2 | 1,200,000 | Satisfactory | None |
| Example 3 | 5.3 | 1,200,000 | Satisfactory | None |
| Example 4 | 5.2 | 1,200,000 | Satisfactory | None |
| Example 5 | 5.4 | 1,200,000 | Satisfactory | None |
| Example 6 | 5.2 | 1,200,000 | Satisfactory | Wrinkled |
| Comparative | 5.4 | 250,000 | Problematic | None |
| Example 1 | | | | |
| Comparative | 5.2 | 400,000 | Problematic | None |
| Example 2 | | | | |
| Comparative | 5.5 | 450,000 | Problematic | None |
| Example 3 | | | | |
| Comparative | 5.4 | 500,000 | Problematic | None |
| Example 4 | | | | |

The results shown in Table 2 indicate that the pressure members of Examples 1 to 6, each having the surface layer as described in the exemplary embodiment, develop no crack even when fixing is performed on 1,200,000 sheets, and no wrinkle appears on the roll surfaces of the pressure members of Examples 1 to 5. On the other hand, the pressure members of Comparative Examples 1 to 4, in which the content ratio of perfluoroalkyl vinyl ether in the fluororesin (x value in the formula (1)) is less than 4.5 mol %, develop cracks when or before fixing is performed on 500,000.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A pressure member used for fixing in electrophotography, comprising at least:
a substrate;
an elastic layer provided on the substrate; and
a surface layer that is provided on the elastic layer and includes carbon and a fluororesin having a structure represented by the following Formula (1): 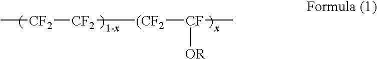
wherein, in Formula (1), R represents CF₃, C₂F₅, or C₃F₇, and x represents a numeral from 0.045 to 0.12.

2. The pressure member of claim 1, wherein x in Formula (1) represents a numeral from 0.045 to 0.10.

3. The pressure member of claim 1, wherein R in Formula (1) represents CF₃ or C₂F₅.

4. The pressure member of claim 1, wherein R in Formula (1) represents C₂F₅.

5. The pressure member of claim 1, wherein the carbon content in the surface layer is from 1% by weight to 7% by weight of the total weight of the surface layer

6. The pressure member of claim 1, wherein the volume resistivity of the surface layer is from 10⁴ Ωcm to 10¹⁰ Ωcm.

7. A fixing device for electrophotography, comprising a pressure member and a fixing member in contact with the pressure member;
the pressure member including at least a substrate, an elastic layer provided on the substrate, and a surface layer that is provided on the elastic layer and includes carbon and a fluororesin having a structure represented by the following Formula (1): 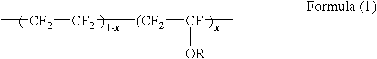
wherein, in Formula (1), R represents CF₃, C₂F₅, or C₃F₇, and x represents a numeral from 0.045 to 0.12.

8. The fixing device of claim 7, wherein x in Formula (1) represents a numeral from 0.045 to 0.10.

9. The fixing device of claim 7, wherein R in Formula (1) represents CF₃ or C₂F₅.

10. The fixing device of claim 7, wherein R in Formula (1) represents C₂F₅.

11. The fixing device of claim 7, wherein the carbon content in the surface layer is from 1% by weight to 7% by weight of the total weight of the surface layer

12. The fixing device of claim 7, wherein the volume resistivity of the surface layer is from 10⁴ Ωcm to 10¹⁰ Ωcm.

13. An image forming apparatus comprising:
an image holder;
an electrostatic latent image forming unit that forms an electrostatic latent image on the image holder;
a developing unit that develops the electrostatic latent image into a toner image with a toner;
a transfer unit that transfers the toner image onto a recording medium; and
a fixing device that fixes the toner image, which has been transferred onto the recording medium, to the recording medium,
the fixing device including a pressure member and a fixing member in contact with the pressure member, the pressure member including at least a substrate, an elastic layer provided on the substrate, and a surface layer that is provided on the elastic layer and includes carbon and a fluororesin having a structure represented by the following Formula (1): 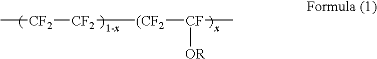
wherein, in Formula (1), R represents CF₃, C₂F₅, or C₃F₇, and x represents a numeral from 0.045 to 0.12.

14. The image forming apparatus of claim 13, wherein x in Formula (1) represents a numeral from 0.045 to 0.10.

15. The image forming apparatus of claim 13, wherein R in Formula (1) represents CF₃ or C₂F₅.

16. The image forming apparatus of claim 13, wherein R in Formula (1) represents C₂F₅.

17. The image forming apparatus of claim 13, wherein the carbon content in the surface layer is from 1% by weight to 7% by weight of the total weight of the surface layer.

18. The image forming apparatus of claim 13, wherein the volume resistivity of the surface layer is from 10⁴ Ωcm to 10¹⁰ Ωcm.
